(19) United States
(12) Patent Application Publication
(10) Pub. No.: US 2012/0023817 A1
(43) Pub. Date: Feb. 2, 2012

(54) AUTONOMOUS ANTI-SPILL CARRIER FOR A BOUQUET OF FLOWERS

(76) Inventor: Philippe Charrin, Beaumont-Monteux (FR)

(21) Appl. No.: 13/128,689

(22) PCT Filed: May 6, 2009
(86) PCT No.: PCT/EP2009/003229

§ 371 Date: Jul. 27, 2011

(30) Foreign Application Priority Data
Nov. 14, 2008 (LU) LU 91496

(51) Int. Cl. A01G 5/06

(52) U.S. Cl. 47/41.13

(57) ABSTRACT

The present invention relates to a carrier for a bouquet of flowers, constituted of a container (1) which defines an internal volume (2) and which has, at one of the ends thereof, a lower base (3) and, at the opposite end, an upper part (4), said lower base (3) having an upper surface at the surface of the upper part (4), said upper part (4) having at least one opening (5), said opening (5) extending from the upper part (4) into the internal volume (2) by means of a skirt (6), characterized in that the lower base (3) is open and the container with an open lower base can be wrapped in a sheet of leak tight packaging (10) placed under the lower base (3) of the container and pulled up along the wall (11) of the container, wherein the container with an open lower base-sheet of leak tight packaging (10) assembly forms a water-tight closed container (1), and wherein the container with an open lower base-sheet of leak tight packaging assembly is kept in place by means of a tie (12).

The present invention relates to a carrier for a bouquet of flowers according to claim 1.

The state of the art comprises a carrier for the base of a Christmas tree; however, this type of carrier is part of a technical field (trees) distant from the field of bouquets of flowers and still has a closed lower base. A person skilled in the art would never have taken it into consideration for inventive step.

There are different types of carriers for bouquets with a store of water, but none of these combine the carrier and autonomous container functions, and they are all faced with the problem of water spilling outside the carrier in the event the latter is knocked over.

The carrier as defined in claim 1 of the present invention is a solution to the problem of flower bouquet carriers with water supplies tipping over during transport.

The invention is made up of an open and planar base and, in its opposite part, a skirt that can descend back into the volume or remain on a flat level by reducing the diameter in proportion to the base; a more or less substantial volume is then obtained.

The present invention relates to a carrier for a bouquet of flowers, constituted of a container (1) which defines an internal volume (2) and which has, at one of the ends thereof, a lower base (3) and, at the opposite end, an upper part (4), said lower base (3) having an upper surface at the surface of the upper part (4), said upper part (4) having at least one opening (5), said opening (5) extending from the upper part (4) into the internal volume (2) by means of a skirt (6). The upper part (4) having at least one opening (5) whereof the diameter can be smaller than or equal to the diameter of the upper part (4).

The carrier according to the present invention can be tapered and its lower base (3) is planar, the lower base (3) can be open or closed and the circular upper part (4) can also be planar.

The carrier according to the present invention comprises a skirt (6) that extends from the upper part (4) towards the lower base (3) without, however, resting on said lower base (3).

The height (h1) of the skirt of the carrier according to the present invention can correspond to ¼, ⅓, ½, ⅔, ¾ of the total height (H) of the container (1). The skirt (6) can be a continuous peripheral skirt or a skirt provided with at least one opening (7) on its periphery. The skirt (6) can be provided with at least one opening, said skirt extending from the upper part (4) towards the lower base (3), and the skirt (6) can rest on said lower base (3).

The lower opening (8) of the skirt (6) can be situated near the lower base (3).

The skirt (6) can serve as a dam to prevent the flow of a store of water (16) outside the sealed container (1) in the event the sealed container (1) tips over.

The skirt (6) can be cylindrical, conical, tapered, pyramidal, or barrel-shaped.

A lid (9) or other closing means can be fastened (by stapling, welding, clipping, adhesion or any other male-female fastening means) to the lower base (3) of the container (1) in order to form a sealed container.

The lid (9) can comprise, along its periphery, a plurality of strips (13) secured to the lid (9) and able to be folded down along the wall (11) of the container in order to stabilize the bouquet of flowers.

Furthermore, in all of the scenarios described, complete stability of the bouquet is guaranteed as well as maintenance of the water inside the container (1) in the event the carrier is accidentally tipped over.

The lower base (3) of the carrier according to the present invention can be open and the container (1) with an open lower base can be surrounded by a sheet of leaktight packaging (10), decorative or non-decorative, placed under the lower base of the container and raised up along the wall (11) of the container, the carrier (1) with the open base (3) may also be placed (FIG. 5) and welded or adhered to the packaging sheet (10) in order to seal the opening (3), the assembly of the container with the open lower base and the leaktight packaging sheet (10) forming a leaktight closed container (1), the assembly of the container with an open lower base and the leaktight packaging sheet being kept in place by a tie (12).

The leaktight container (1) can be completely surrounded by a conical device for displaying a bouquet of flowers (15), which either can be fastened to the lid (9) (by stapling, welding, clipping, adhesion, or any other fastening means), or can simply rest on the lid (9).

A conical device for displaying a bouquet of flowers (14) can also rest on the upper part (4) of the container, the assembly of the container (1)—conical flower bouquet display device (14) having a conical shape.

An object able to retain the water (16) by absorption (e.g. a sponge or foam) can be placed in the inner volume (2) of the container (1) in order to better retain the water while preventing it from spreading, and returning the water by gravity when the bouquet is returned to a vertical position.

An impermeable (leaktight) sheet can cover all (without exception) of the embodiments of the present invention.

The lower base (3) of the carrier according to the present invention can have an edge with an outer or inner stabilizing bulge (16). The lower base (3) can be circular, square, rectangular, in a figure eight, clover-shaped, star-shaped, a pentagon, hexagon, heptagon, octagon, or triangular.

The carrier can be made from any material (e.g. rigid plastic material, wood, metal, impermeable cardboard, etc.).

The lower base (3) can have any shape and the upper part (4) is preferably round.

### FIGURES

FIG. 1a: shows the container (1) according to the present invention before introducing the bouquet of flowers therein.

FIG. 1b: shows the container (1) according to the present invention after introducing the bouquet of flowers therein. The skirt (6) having an upper opening and a lower opening through which the stems of the bouquet of flowers are introduced inside the container (1).

FIG. 1c: shows a cross-sectional view of the container (1) according to the present invention after introducing the bouquet of flowers therein.

FIG. 2a: shows the container (1) according to the present invention with a cylindrical skirt (6) seen transparently through the container (1).

FIG. 2b: shows the carrier according to the present invention (seen in a non-transparent view) with its lower base (3) having a border with an outer or inner stabilizing bulge (16).

FIG. 2c: shows the container (1) according to the present invention with a conical skirt (6) seen in a transparent view through the container (1).

FIG. 3: shows the container (1) according to the present invention and a lid (9), with a rim on the entire circumference thereof, which can be fastened to the container (1). The skirt (6) being perforated (7) in the lower part thereof. With clipping of a lid on the lower base the invention becomes a leaktight container (vase).

FIG. 4: shows the container (1) according to the present invention and a lid (9) without a rim that can be fastened to the container (1). Sealing can also be obtained by heat sealing or HF or adhesion of a simple sheet called a sealing membrane.

FIG. 5: shows the container (1) according to the present invention with its skirt (6) seen through transparent view and an impermeable sheet (10) placed under the lower base (3) of the carrier. Savings can be obtained relative to the closing or sealing membrane system by welding directly on the leaktight packaging sheet or by equipping the impermeable sheet or the lower base of the carrier with any adhesive means in order to make the inner volume of the carrier leaktight.

FIG. 6a: shows the container (1) without water according to the present invention surrounded by an impermeable sheet (10) raised up along the walls (11) of the container (1), the entire assembly being maintained by a tie (12).

FIG. 6b: corresponds to the carrier according to FIG. 6a with water (16) inside the container (1). In any case, the operator need only make the stems of the bouquet penetrate inside the volume of the skirt (6), raise the sheet on the wall (11) of the carrier, and attach the entire assembly using any suitable means, such as a tie (12) to restore a bouquet shape with a store of water.

FIG. 6c: corresponds to the carrier of FIG. 6b tipped over and this figure shows that the water (16) does not flow outside the carrier owing to the combination of the characteristics of the carrier.

FIG. 7a: shows the container (1) with water (16), the container (1) being topped by a conical device for displaying a bouquet of flowers.

FIG. 7b: shows the container (1) assembly with water (16) and the conical device for displaying bouquets of flowers in the final usage position.

FIG. 8a: shows the container (1) without water according to the present invention without a lid whereof the perimeter of the lower base (3) is provided with strips (13).

FIG. 8b: shows the container (1) without water according to the present invention with strips (13) raised up along the wall (11) of the container and improving the stability of the bouquet of flowers in the upright position.

FIG. 9: shows the container (1) without water according to the present invention which can be fastened on a lid (9) whereof the perimeter is provided with strips (13).

FIG. 10a: shows the container (1) without water according to the present invention with a device for displaying a bouquet of flowers (14) resting on the upper part (4) of the container (1).

FIG. 10b: shows the device for displaying a bouquet of flowers (14) assembled to the container (1) without water according to the present invention. In this case the carrier retains water autonomously by “blocking” a certain amount of water in the hollow part in the event the bouquet alone or the bouquet in its packaging tips over. The carrier is thus righted by a “Bouquett'o® style” cone to complete its height and improve the stability and maintenance of the bouquet.

FIG. 11a: shows the container (1) with the opening (5) occupying the majority of the surface of the upper part (4). The upper part (4) forms a perimeter (4a).

FIG. 11b: shows a side view of the container (1) according to FIG. 11a.

FIG. 11c: shows a top view of the container (1) of FIG. 11a.

FIG. 12: shows the container (1) with a circular lower base and concave side walls (i.e. with a hollow curve).

FIG. 13: shows the container (1) with a circular lower base and straight side walls (i.e. without curve).

FIG. 14: shows the container (1) with a clover-shaped lower base and straight side walls (i.e. without curve).

FIG. 15: shows the container (1) with a star-shaped lower base and straight side walls (i.e. without curve).

FIG. 16: shows the container (1) with a triangular lower base and straight side walls (i.e. without curve).

FIG. 17: shows the container (1) with a lower base having a complex geometric shape and straight side walls (i.e. without curve).

FIG. 18: shows the container (1) with a circular lower base and straight side walls (i.e. without curve).

FIG. 19: shows the container (1) with a circular lower base and curved side walls.

FIG. 20: shows the container (1) with a square lower base and straight side walls.

FIG. 21: shows the container (1) with a figure eight-shaped lower base and straight side walls.

FIG. 22: shows the container (1) with a hexagonal lower base and straight side walls.

FIG. 23: shows the container (1) with an octagonal lower base and straight side walls.

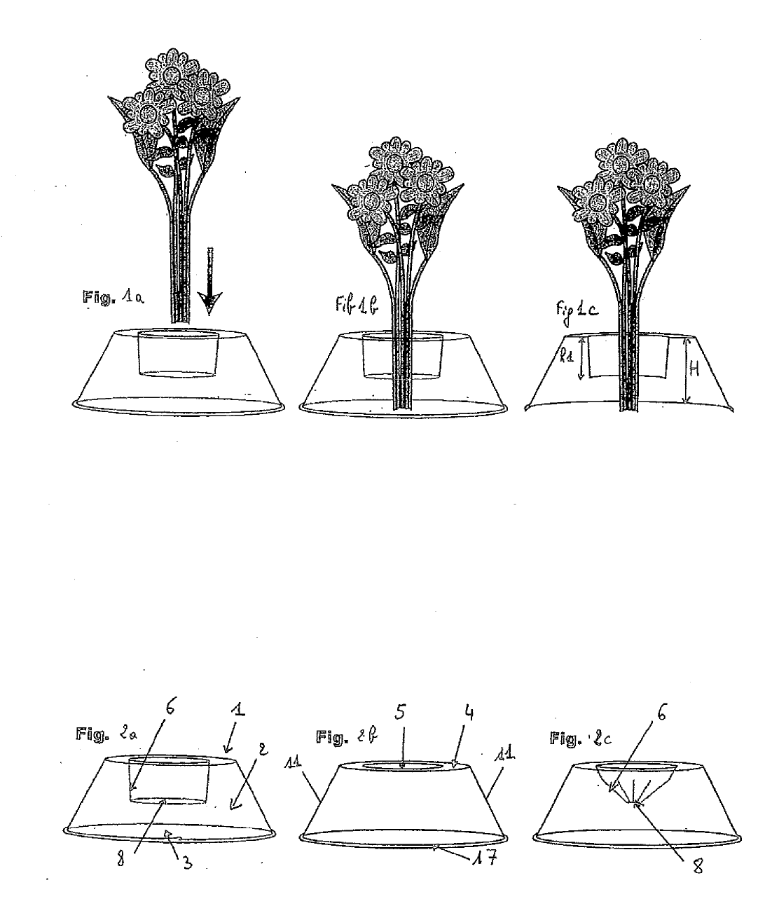

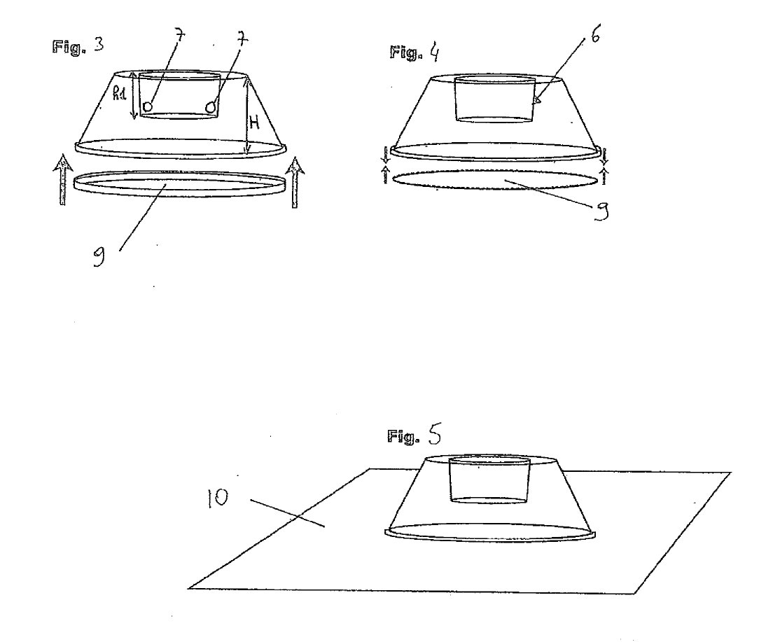

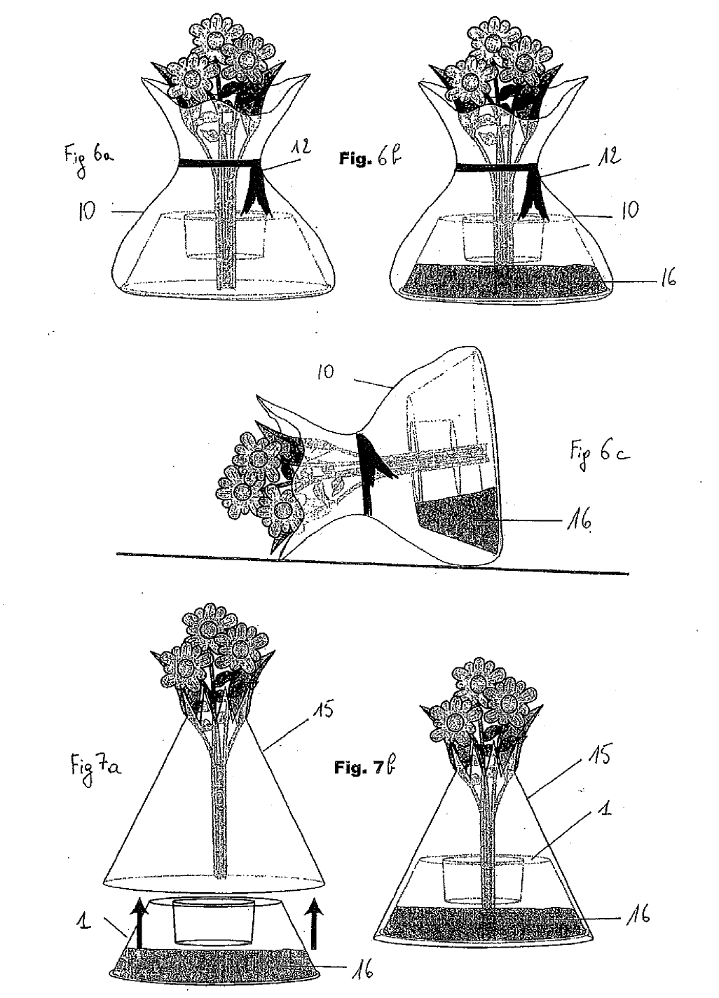

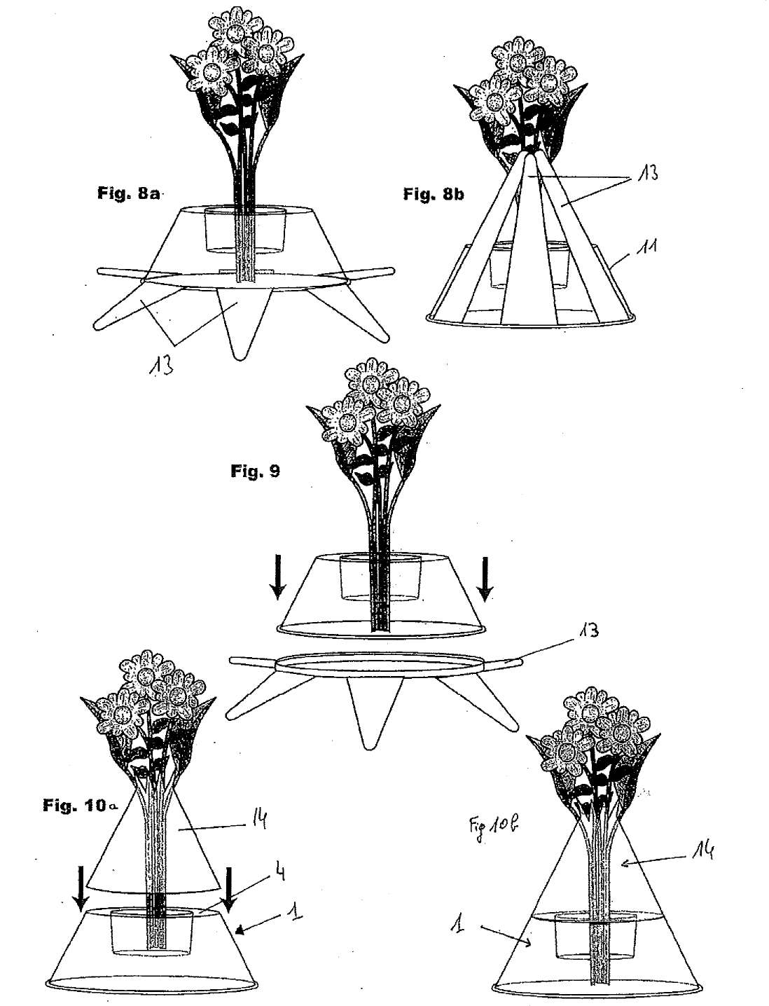

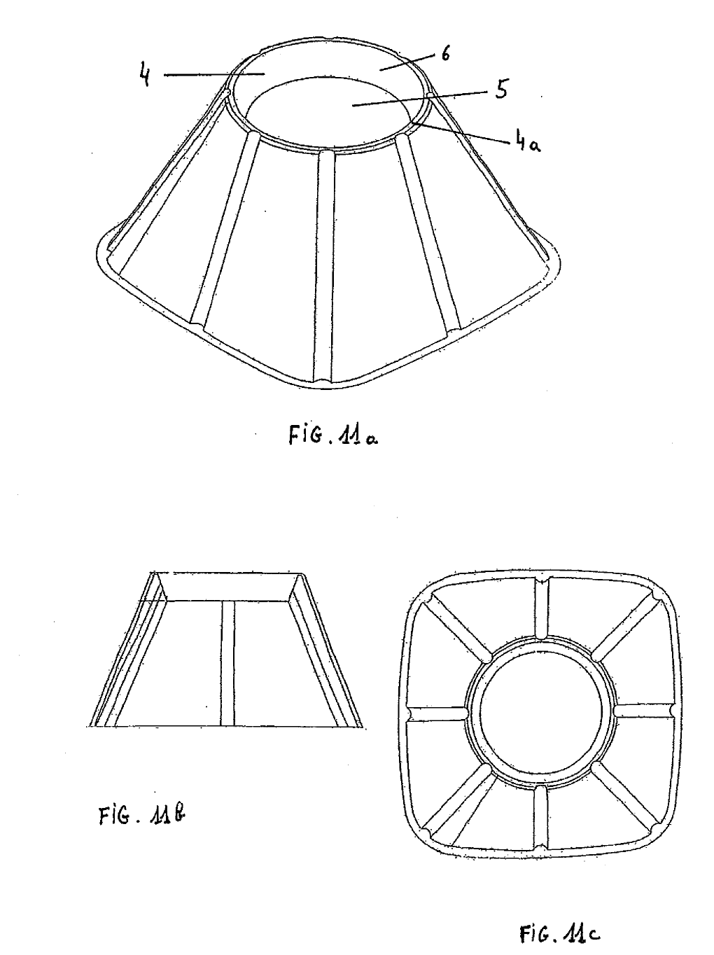

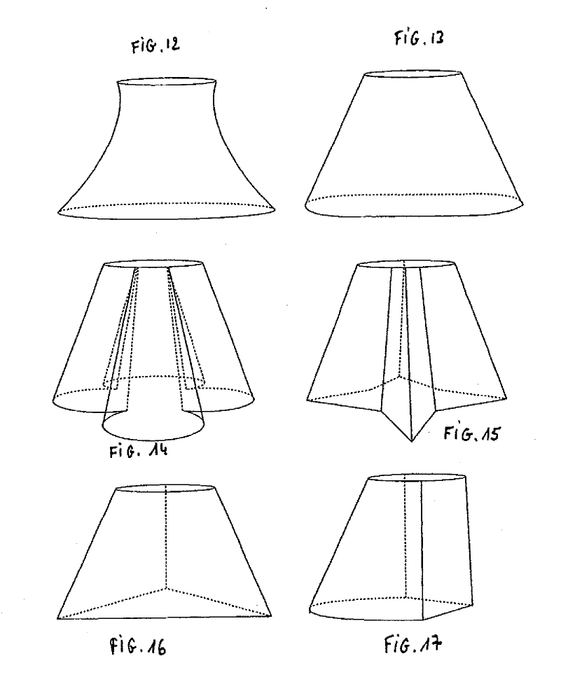

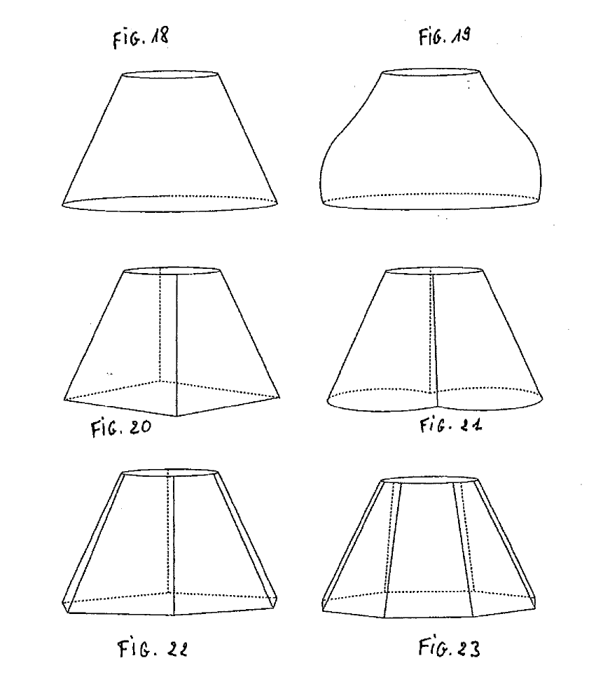

1. A carrier for a bouquet of flowers, constituted of a container (1) which defines an internal volume (2) and which has, at one of the ends thereof, a lower base (3) and, at the opposite end, an upper part (4), said lower base (3) having an upper surface at the surface of the upper part (4), said upper part (4) having at least one opening (5), said opening (5) extending from the upper part (4) into the internal volume (2) by means of a skirt (6)
characterized in that the lower base (3) is open and the container with an open lower base can be wrapped in a sheet of leaktight packaging (10) placed under the lower base (3) of the container and pulled up along the wall (11) of the container, wherein the container with an open lower base-sheet of leaktight packaging (10) assembly forms a watertight closed container (1), the container with an open lower base-sheet of leaktight packaging assembly being kept in place by means of a tie (12).

2. The carrier according to claim 1, characterized in that the carrier is tapered with its lower base (3) being planar and open or closed, and the circular upper part (4) also being planar.

3. The carrier according to claim 1, characterized in that the skirt (6) is a skirt that extends from the upper part (4) towards the lower base (3) without, however, resting on said lower base (3).

4. The carrier according to claim 3, characterized in that the height (h1) of the skirt corresponds to ¼, ⅓, ½, ⅔, ¾ of the total height (II) of the container (1).

5. The carrier according to claim 4, characterized in that the skirt (6) is a continuous peripheral skirt or a skirt provided with at least one opening (7) on its periphery.

6. The carrier according to claim 1, characterized in that the skirt (6) is a skirt provided with at least one opening, said skirt extending from the upper part (4) towards the lower base (3), and the skirt (6) rests on said lower base (3).

7. The carrier according to claim 6, characterized in that the lower opening (8) of the skirt (6) is situated near the lower base (3).

8. The carrier according to claim 1, characterized in that the skirt (6) serves as a dam to prevent the flow of a store of water outside the sealed container (1) in the event the sealed container (1) tips over.

9. The carrier according to claim 1, characterized in that a lid (9) or other closing means is fastened to the lower base (3) of the container (1) in order to form a sealed container.

10. The carrier according to claim 8, characterized in that the skirt (6) is cylindrical, conical, tapered, pyramidal, or barrel-shaped.

11. The carrier according to claim 9, characterized in that the lid (9) comprises, along its periphery, a plurality of strips (13) secured to the lid (9) and able to be folded down along the wall (11) of the container in order to stabilize the bouquet of flowers.

12. The carrier according to claim 9, characterized in that the leaktight container (1) can be completely surrounded by a conical device for displaying a bouquet of flowers (15), which either can be fastened to the lid (9), or can simply rest on the lid (9).

13. The carrier according to claim 9, characterized in that a conical device for displaying a bouquet of flowers (14) can rest on the upper part (4) of the container, the assembly of the container (1)—conical flower bouquet display device (14) having a conical shape.

14. The carrier according to claim 1, characterized in that an object able to retain the water (16) by absorption is placed in the inner volume (2) of the container (1).

15. The carrier according to claim 1, characterized in that the lower base (3) is circular, square, rectangular, in a figure eight, clover-shaped, star-shaped, a pentagon, hexagon, heptagon, octagon, or triangular.

16. The carrier according to claim 1, characterized in that the carrier (1) with the open base (3) can be placed, welded, or adhered to the packaging sheet (10) in order to seal the opening of the open base (3).
